(19) United States
(12) Patent Application Publication
(10) Pub. No.: US 2016/0264848 A1
(43) Pub. Date: Sep. 15, 2016

(54) METHODS AND SYSTEMS FOR HYDROCARBON RECOVERY

(71) Applicant: INDIAN INSTITUTE OF TECHNOLOGY MADRAS, Chennai (IN)

(72) Inventor: Jitendra SANGWAI, Dist Buldhana (IN)

(21) Appl. No.: 14/634,662

(22) Filed: Feb. 27, 2015

(30) Foreign Application Priority Data
Feb. 28, 2014 (IN) 1033/CHE/2014

(51) Int. Cl. C09K 8/588; E21B 47/00; E21B 47/06; E21B 43/16; E21B 43/20

(52) U.S. Cl. CPC C09K 8/588; E21B 43/16; E21B 43/20; E21B 47/065; E21B 47/00; C09K 2208/10

(57) ABSTRACT

Methods and systems for hydrocarbon material recovery include injecting a monomer-containing solution into a subterranean formation that contains some amount of a hydrocarbon material. The monomer-containing solution includes at least one monomer that may polymerize into a polymer when exposed to a temperature above a monomer polymerization temperature. The subterranean formation may be at a temperature about equal to or greater than the polymerization temperature. Thus, the monomer-containing solution may polymerize in the formation based on temperature. Additional chemical polymerization agents may not be needed for polymerization.

### CLAIM OF PRIORITY

This application claims priority benefit under 35 U.S.C. §119(a) of Indian Patent Application No. 1033/CHE/2014 filed Feb. 28, 2014, entitled “Methods and Systems for Hydrocarbon Recovery,” the disclosure of which is herein incorporated by reference in its entirety.

### BACKGROUND

The energy demand of the world has increased significantly due to increased population, economic growth, and increased industrial activities. A significant amount of the energy demand is met through the use of hydrocarbon-based fuels. Petrochemical production, also on the rise, is an additional consumer of hydrocarbon feed stocks. New sources of such hydrocarbons (or hydrocarbon materials) are being discovered, but additional hydrocarbon still remains untapped in mature oilfields. In some instances, as much as two thirds of the originally discovered crude oil remains unproduced. Much of the unused hydrocarbon may be left behind in subterranean formations at least in part due to the physics of fluid flow in porous materials. In addition, a potential supply of hydrocarbon may be found in subterranean formations having unconventional characteristics (for example, oil in fractured shales, kerogen in oil shale, and bitumen in tar sands) that may prevent hydrocarbon recovery using standard extraction methods.

Enhanced oil recovery (EOR) technologies may be used to recover hydrocarbons from such otherwise unproductive sources. Enhanced oil recovery (EOR) processes may include chemical injection methods, miscible or near miscible gas injection methods, thermal methods, and microbial injection methods, among others. Such methods generally include injecting a recovery fluid (gas or liquid) into the formation to maintain extraction pressure and to increase the efficiency of the hydrocarbon extraction from the formation.

It may be necessary to use injection methods and fluids designed for specific recovery sites. For example, specific recovery fluids may be required to extract particular types of hydrocarbons—such as gas, light oil, brown oil, and heavy oil—based, at least in part, on the hydrocarbon viscosity and density. Recovery fluids and extraction processes may also be tailored to specific characteristics of the subterranean formations in which the hydrocarbons may be found. Such geological characteristics may include formation porosity, formation average density, formation permeability, formation pore size, formation pore size distribution, and the chemical composition of the rock or sand comprising the formation. Because detailed knowledge of the hydrocarbon composition and/or subterranean environment may be difficult to obtain, producers may possess inadequate knowledge of the geology and hydrocarbon composition at a given recovery site. As a result, producers may employ inefficient means to recover residual hydrocarbons from the site. It is therefore desirable to develop an EOR technology that can be adjusted at the recovery site to maximize potential hydrocarbon recovery.

### SUMMARY

In an embodiment, a method of treating a subterranean formation may include contacting the subterranean formation with a monomer-containing solution and allowing at least a portion of the monomer-containing solution to at least partially polymerize in the subterranean formation for a polymerization time, thereby forming at least one polymer within the subterranean formation. In an embodiment of the method, the monomer-containing solution may include at least one monomer, the subterranean formation may have a formation temperature, the monomer-containing solution may have a polymerization temperature above which the at least one monomer in the monomer-containing solution may be thermally catalyzed to form the at least one polymer, and the formation temperature may be equal to or greater than the polymerization temperature.

In an embodiment, a method of extracting a hydrocarbon from a subterranean formation may include contacting the subterranean formation with a monomer-containing solution, allowing at least a portion of the monomer-containing solution to at least partially polymerize in the subterranean formation for a polymerization time, thereby forming at least one polymer within the subterranean formation, injecting a flooding fluid into the subterranean formation, and removing the hydrocarbon from the subterranean formation. In an embodiment, the monomer-containing solution may include at least one monomer, the subterranean formation may have a formation temperature, the monomer-containing solution may have a polymerization temperature above which the at least one monomer in the monomer-containing solution may be thermally catalyzed to form the at least one polymer, and the formation temperature may be equal to or greater than the polymerization temperature.

In another embodiment, a system may include at least one injection well in fluid communication with at least one subterranean formation, at least one production well in fluid communication with the at least one subterranean formation, and a pumping device configured to pump a monomer-containing solution into the at least one subterranean formation via the at least one injection well. In an embodiment, the monomer-containing solution may include at least one monomer, the subterranean formation may have a formation temperature, the monomer-containing solution may have a polymerization temperature above which the at least one monomer in the monomer-containing solution may be thermally catalyzed to form at least one polymer, and the formation temperature may be equal to or greater than the polymerization temperature.

### BRIEF DESCRIPTION OF THE DRAWINGS

FIG. 1 illustrates an embodiment of a section of formations and a reservoir of a hydrocarbon in accordance with the present disclosure.

FIG. 2 illustrates an embodiment of an expanded view of a subterranean formation including a portion of a hydrocarbon reservoir in accordance with the present disclosure.

FIG. 3 is a flow diagram of an embodiment of a method of treating a subterranean formation in accordance with the present disclosure.

FIG. 4 is a flow diagram of an embodiment of a method of extracting a hydrocarbon from a subterranean formation in accordance with the present disclosure.

FIG. 5 illustrates one embodiment of a system for extracting a hydrocarbon from a subterranean formation in accordance with the present disclosure.

### DETAILED DESCRIPTION

Chemical enhanced oil recovery (CEOR) techniques may be candidates for enhancing oil recovery, for example from mature oil fields. Such techniques may include, without limitation, polymer flooding, polymer-surfactant (or polymer-micellar) flooding, and alkaline-surfactant-polymer (ASP) flooding. CEOR techniques may include the use of a polymer to increase the viscosity of the recovery solution and to improve the efficiency of hydrocarbon recovery from the subterranean formations.

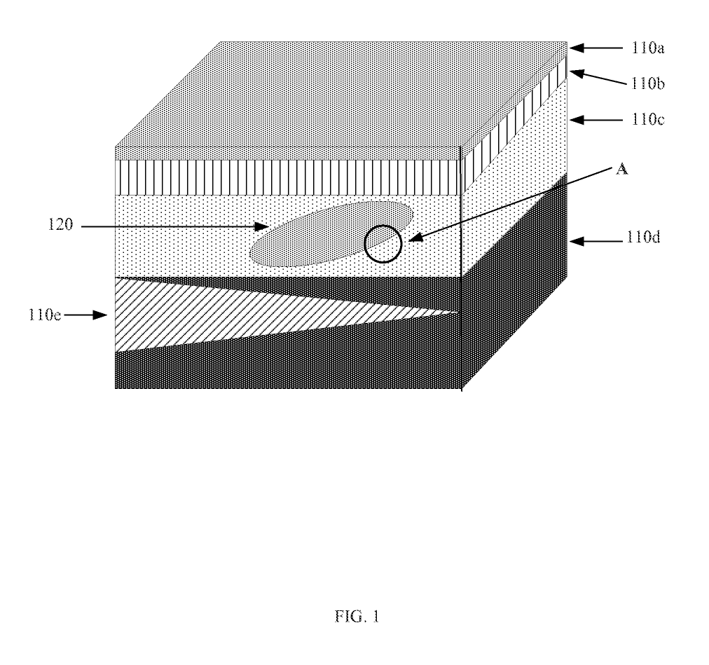

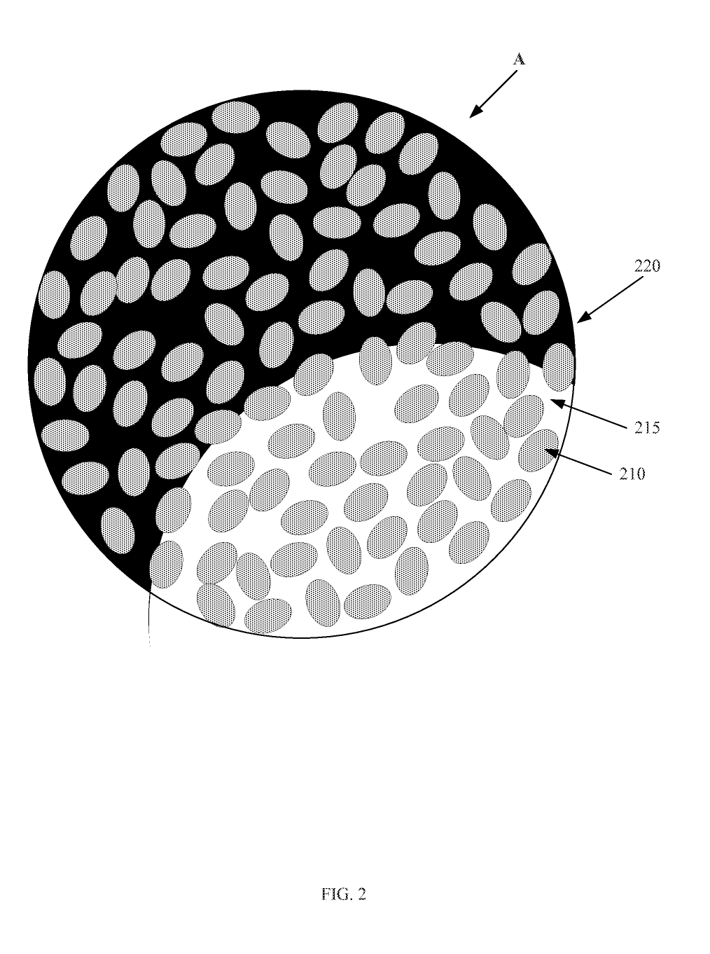

FIG. 1 depicts a non-limiting example of hydrocarbon embedded within subterranean formations. Subterranean formations 110a-110e may comprise a variety of materials including, without limitation, sandstone, shale, granite, limestone, and composites. Some formations 110a-110e may overlay lower formations (such as 110a overlaying 110b, and 110b overlaying 110c). Alternatively, some formations (such as 110e) may intrude into pre-existing formation, such as 110d. Hydrocarbon 120 may be found dispersed within one or more formations (such as 110c). The hydrocarbon 120 may be diffused throughout an entire formation (such as 110c), or may be found in one or more contained regions or reservoirs of material (as illustrated by 120 in FIG. 1). An interface region A between the hydrocarbon reservoir 120 and the formation 110c is depicted in an expanded view in FIG. 2.

FIG. 2 depicts an expanded view of the interface region A between a hydrocarbon-containing reservoir within a subterranean formation, and the remainder of the formation material that does not contain the hydrocarbon. The subterranean formation may comprise solid grains 210 and pores 215 therebetween. The pore size (diameter) may vary depending on the type of formation material in which the pores are found. In one non-limiting example, the pores may be greater than about 2000 μm in some conventional subterranean formation. In some gas-tight sandstones, the pore size may be from about 30 μm to about 2000 μm. In some shale formations, the pore size may be from about 0.01 μm to about 100 μm. Non-limiting examples of a pore size may include about 0.01 μm, about 0.02 μm, about 0.05 μm, about 0.1 μm, about 0.2 μm, about 0.5 μm, about 1 μm, about 2 μm, about 5 μm, about 10 μm, about 20 μm, about 50 μm, about 100 μm, about 200 μm, about 500 μm, about 1000 μm, about 2000 μm, about 5000 μm, and ranges between any two of these values (including endpoints). The hydrocarbon may fill some pores to form the reservoir space 220. Some non-limiting mechanisms that may affect hydrocarbon displacement processes from the formation may include pore 215 geometry, the chemical composition of the grains 210, and the density, viscosity, and surface tension of the hydrocarbon. Such factors may have an impact on the efficiency of polymer mixtures for removing the hydrocarbon.

It may be appreciated that the polymer molecular weight and size may have an impact on the ability of the polymer to reach the hydrocarbon through the pores 215. The ability of the polymer to reach the hydrocarbon in the reservoir space 220 may decrease as the polymer molecular weight and size increases with respect to the pore 215 size. Therefore, the size of the polymer for injection into the formation may be chosen to maximize its penetration into the pores 215. The efficiency of a polymer-containing solution for removing the hydrocarbon from the subterranean formation may also depend, at least in part, on matching the density and viscosity of a polymer-containing solution to that of the hydrocarbon. Therefore, an efficient recovery process may depend on optimizing a polymer size and weight to the conditions of the formation and the hydrocarbon to be extracted. It may be appreciated, however, that pore 215 size and grain 210 size and composition may not be readily determined for any specific hydrocarbon reservoir. In some non-limiting examples, a hydrocarbon reservoir may extend across different types of subterranean formations, and therefore the formation porosity and composition may vary across the hydrocarbon reservoir. Thus, it may be difficult to optimize the polymer size for a specific oil field.

A polymer-containing solution optimized for hydrocarbon extraction under a specific set of formation and hydrocarbon conditions may be dense and viscous, thereby producing a significant hydrodynamic load on pumping equipment. Such a hydraulic load may increase the energy cost for pumping the polymer solution, especially into shale reservoirs and heterogeneous reservoirs (as non-limiting examples).

It is, therefore, desirable to develop systems and methods for introducing optimized polymer materials into hydrocarbon reservoirs, which may overcome some of the limitations disclosed above.

In one non-limiting embodiment, the polymer may be introduced into the reservoirs by contacting the reservoir with a solution containing one or more thermo-polymerizable monomers. Such monomers may be characterized by a polymerization temperature, above which the monomers may thermally polymerize. The hydrocarbon reservoirs may be located in formations that naturally have a temperature about equal to or above the polymerization temperature. As a result, the monomer-containing solutions, once introduced into the formation, may begin to polymerize due solely to the formation temperature. It may be appreciated that, under such conditions, polymerization agents may not be necessary to cause polymerization.

Since the monomers may be small molecules, they may be able to infiltrate pores and voids within the subterranean formation that are too small for larger polymers to enter. As a result of the formation temperature, the monomers may begin to polymerize in situ. The size of the pores and voids within the formation may thus act to control the size of polymer formation, and the polymers created under such conditions may self-adjust to an optimal size. In addition to the physical constrains on polymer size due to the size of the voids within the formation, the time for monomer polymerization (a polymerization time) may be controlled before the polymer solution/hydrocarbon is swept out of the formation with a flooding solution.

Several benefits may be realized from the use of thermo-polymerizable monomers. As disclosed above, the polymer size may be controlled by the formation environment, and thus pre-selection of a polymer size may be unnecessary. Therefore, prior knowledge of the formation geology may not be necessary, and a single type of monomer-containing solution may be used regardless of the nature of the formation.

Additionally, the use of a thermo-polymerizable material may make the addition of polymerizing agents unnecessary. As a result, the complexity and cost of the process for injecting the monomer-containing solution may be reduced. Further, a monomer-containing solution may have a lower density and/or viscosity than a solution containing a polymerized form of the monomer. The lower density or viscosity can result in a lower hydrostatic load on a pumping device, with a concomitant reduction in energy use.

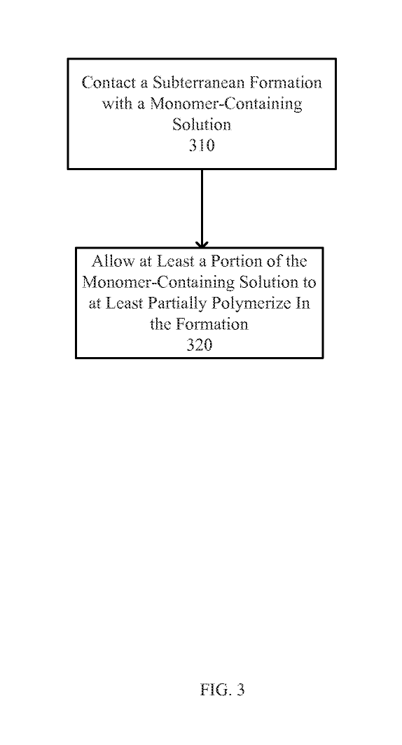

FIG. 3 is a flow chart of an illustrative method of treating a subterranean formation to recover hydrocarbons found therein. The formation may be contacted 310 with a monomer-containing solution including one or more monomer, which may be characterized in part by a polymerization temperature, as disclosed above. The solution may then be allowed to at least partially polymerize 320 in situ based at least in part on the formation temperature, the polymerization temperature, and the amount of time allowed for the polymerization step to continue (the polymerization time).

In some non-limiting examples, the subterranean formation may be one or more of sandstone, shale, and a carbonate. The subterranean formation subjected to the method disclosed above may be located about 30 meters to about 5000 meters below the ground surface. Non-limiting examples of the depth of the formation below the ground surface may include depths of about 30 meters, about 40 meters, about 50 meters, about 100 meters, about 200 meters, about 300 meters, about 400 meters, about 500 meters, about 600 meters, about 700 meters, about 800 meters, about 900 meters, about 1000 meters, about 1500 meters, about 2000 meters, about 2500 meters, about 3000 meters, about 3500 meters, about 4000 meters, about 4500 meters, about 5000 meters, and ranges between any two of these values (including endpoints).

In some non-limiting embodiments, contacting the subterranean formation with a monomer-containing solution may include pumping the monomer-containing solution into the subterranean formation via at least one injection well.

In some non-limiting embodiments, at least one monomer in the monomer-containing solution may include one or more of a saccharide, an acrylamide, an acrylic acid, a salt of acrylic acid, and a vinyl alcohol. The monomer-containing solution may further include a solvent. Non-limiting examples of the solvent in the monomer-containing solution may include one or more of water, benzene, toluene, an alcohol, a light hydrocarbon, and a soluble gas. Non-limiting examples of a light hydrocarbon may include one or more of a hexane, a heptane, an octane, a nonane, and a decane. In some non-limiting examples, the solvent may further include a soluble gas such as one or more of nitrogen, carbon dioxide, and a hydrocarbon gas.

In some alternative embodiments, the monomer-containing solution may be an emulsion, further including a surfactant. Non-limiting examples of such a surfactant may include one or more of sodium dodecyl sulfate, sodium dodecylbenzenesulfonate, perfluorooctanoic acid, potassium lauryl sulfate, ammonium lauryl sulfate, dioctyl sodium sulfosuccinate, sodium laureth sulfate, sodium lauroyl sarcosinate, cetyltrimethylammonium bromide, and nonylphenol ethoxylate.

In yet another embodiment, the monomer-containing solution further includes an alkali material. Non-limiting examples of such alkali material may include one or more of sodium hydroxide, sodium carbonate, potassium hydroxide, calcium hydroxide, and magnesium hydroxide.

In still another non-limiting embodiment, the monomer-containing solution may additionally include at least one proppant. Non-limiting examples of such proppants may include one or more of a sand, a synthetic sand, a clay, and a plurality of nanoparticles. Non-limiting examples of such nanoparticles may include silica, nickel, copper zinc, iron, clay SiO₂, Al₂O₃, CuO, ZnO, Ni₂O₃, MgO, carbon nanotubes, carbon nanorods, zeolites, gold, silver, platinum, and rhenium.

In some embodiments, the monomer-containing solution may not include a polymerization initiator of the at least one monomer. For example, the monomer-containing solution may not include a radical polymerization initiator or a thermal polymerization initiator.

In some non-limiting examples, the at least one monomer may be present in the monomer-containing solution at a concentration of about 1% by volume to about 95% by volume. The concentration of the at least one monomer in the monomer-containing solution, as non-limiting examples, may include about 1% by volume, about 2% by volume, about 3% by volume, about 4% by volume, about 5% by volume, about 10% by volume, about 20% by volume, about 30% by volume, about 40% by volume, about 50% by volume, about 60% by volume, about 70% by volume, about 80% by volume, about 90% by volume, about 95% by volume, and ranges between any two of these values (including endpoints).

Upon polymerization within the formation, the at least one monomer may form a polymer having an average molecular weight. In some non-limiting embodiments, the average molecular weight may be about 0.01 kD to about 10 kD. The average molecular weight of the polymer may include, as non-limiting examples, about 0.01 kD, about 0.02 kD, about 0.03 kD, about 0.04 kD, about 0.05 kD, about 0.1 kD, about 0.2 kD, about 0.3 kD, about 0.4 kD, about 0.5 kD, about 1 kD, about 2 kD, about 3 kD, about 4 kD, about 5 kD, about 10 kD, and ranges between any two of these values (including endpoints). Non-limiting examples of the polymer sizes that can be formed using the method may include sizes of about 1 nm, about 10 nm, about 100 nm, about 1,000 nm, about 10,000 nm, about 100,000 nm and ranges between any two of these values (including endpoints). An alternative characterization of the polymers may be in terms of degree of polymerization. The degree of polymerization expresses the number of monomeric repeat units within a polymer. In some non-limiting embodiments, the degree of polymerization may be about 10 to about 500. Non-limiting examples of the degree of polymerization that can be achieved by this method may include about 10, about 20, about 30, about 40, about 50, about 100, about 200, about 300, about 400, about 500, and values ranging between any two of these values (including endpoints).

As disclosed above, the average molecular weight of the polymer may depend at least in part on the polymerization time. In some non-limiting embodiments, the polymerization time may be based at least in part on one or more of the formation temperature, a pore size of the subterranean formation, and a characteristic of the subterranean formation. Non-limiting examples of such a formation characteristic may include one or more of a formation chemical composition, a formation porosity, a formation density, a formation pore morphology, a formation permeability, and a formation compressibility. In some non-limiting embodiments, the polymerization time may be about 0.5 hours to about 1500 hours. The polymerization time may extend throughout the entire time during which the monomer-containing solution is in contact with the formation. Polymerization may continue as long as the monomer-containing solution is exposed to a formation temperature that is about equal to or greater than the polymerization temperature. Thus, not only may polymerization begin upon initial contact of the solution with the formation (about 0.5 hours from the start of injection), but polymerization may continue throughout the hydrocarbon recovery process, which may be up to several months from the time of injection. Non-limiting examples of a polymerization time may include about 0.5 hours, about 1 hour, about 2 hours, about 3 hours, about 4 hours, about 5 hours, about 10 hours, about 20 hours, about 30 hours, about 40 hours, about 50 hours, about 100 hour, about 200 hours, about 300 hours, about 400 hours, about 500 hours, about 1000 hours, about 1500 hours, and ranges between any two of these values (including endpoints).

As disclosed above, the monomer-containing solution may have a polymerization temperature equal to or less than the formation temperature into which the solution may be introduced. In some non-limiting embodiments, the polymerization temperature may be about 50 degrees C. to about 300 degrees C. Non-limiting examples of polymerization temperatures may include about 50 degrees C., about 100 degrees C., about 150 degrees C., about 200 degrees C., about 250 degrees C., about 300 degrees C., and ranges between any two of these values (including endpoints). In some non-limiting embodiments, the formation temperature may be about 50 degrees C. to about 400 degrees C. Non-limiting examples of polymerization temperatures may include about 50 degrees C., about 100 degrees C., about 150 degrees C., about 200 degrees C., about 250 degrees C., about 300 degrees C., about 350 degrees C., about 400 degrees C., and ranges between any two of these values (including endpoints). It may be appreciated that the polymerization time may be based at least in part on one or more of the polymerization temperature and a concentration of the at least one monomer in the monomer-containing solution. The characteristics of the subterranean formation may also determine, at least in part, the degree of polymerization and hence the polymerization time for a monomer-containing solution. Thus, it may be possible to determine a polymerization time based on measuring the formation temperature and measuring a pore size of samples taken from the subterranean formation.

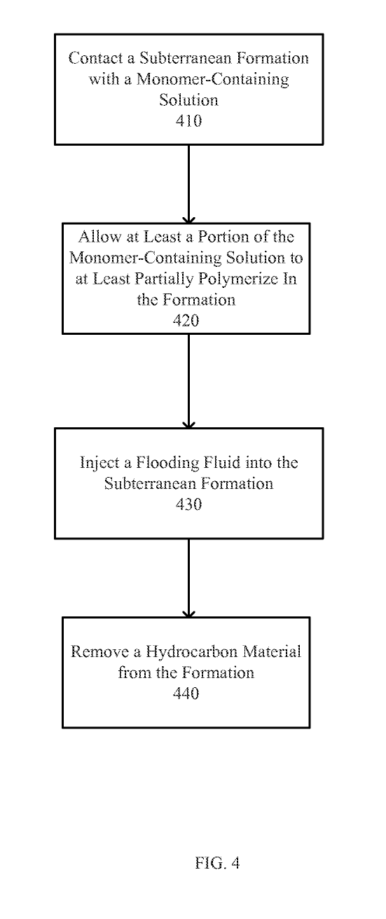

The method illustrated in the flow chart of FIG. 3 may form the basis for a method of extracting hydrocarbon from a deposit or reservoir within a subterranean formation. An embodiment of such an extraction method is depicted in the flow chart of FIG. 4.

FIG. 4 is a flow chart of an illustrative method of extracting hydrocarbon from a subterranean formation. The formation, which may be characterized in part by a polymerization temperature, may be contacted 410 with a monomer-containing solution including one or more monomer as disclosed above. The solution may then be allowed to at least partially polymerize 420 in situ based at least in part on the formation temperature and the amount of time allowed for the polymerization step to continue (the polymerization time). A flooding fluid may be injected 430 into the formation to provide a hydrodynamic force to move the combination polymer material and hydrocarbon. The force of the flooding fluid may thus cause the removal 440 of the hydrocarbon from the formation.

The method disclosed in FIG. 4 may be used to remove the hydrocarbon from the subterranean formation. Some non-limiting examples of such hydrocarbons may include one or more of heavy oil, light oil, brown oil, shale oil, waxy oil, and gas condensate. As disclosed above, several factors may determine the polymerization time of a monomer-containing solution disposed within a formation. Additional factors may be related at least in part on a characteristic of the hydrocarbon. Such hydrocarbon characteristic may include one or more of a material chemical composition, a material density, a material viscosity, and an API gravity (a measurement of materials having a specific gravity less than water).

The flooding fluid injected into the subterranean formation may be used to provide a hydrodynamic force to remove both the hydrocarbon as well as the polymer solution. Such flooding fluids may be injected into the subterranean formation via at least one injection well. The injection well may be the same well or wells used to inject the monomer-containing solution into the subterranean formation. However, the flooding fluid injection well or wells may also differ from one or more wells used to inject the monomer-containing solution. The flooding fluid may include one or more of water, a solvent, an alkali, a surfactant, a co-surfactant such as an alcohol, a biocide such as formaldehyde, an acid, a metal catalyst, a plurality of nanoparticles, and a clay. Some non-limiting examples of alcohols may include methanol, ethanol, propanol, pentanol, and isobutyl alcohol. Some non-limiting examples of acids may include hydrochloric acid, sulfuric acid, and hydrofluoric acid. Non-limiting examples of metal catalysts my include nickel, platinum, iron, rhenium, aluminum hydrosilicate, bauxite, and silica-alumina. Nano-particles may include, without limitation, SiO₂, Al₂O₃, CuO, ZnO, Ni₂O₃, and MgO.

The hydrocarbon may be removed from the subterranean formation via at least one production well. In some non-limiting examples, multiple injection wells may be placed around at least one production well. In an alternative embodiment, multiple production wells may be located around at least one injection well. In yet another non-limiting embodiment, the production well or wells may be the same as the injection well or wells.

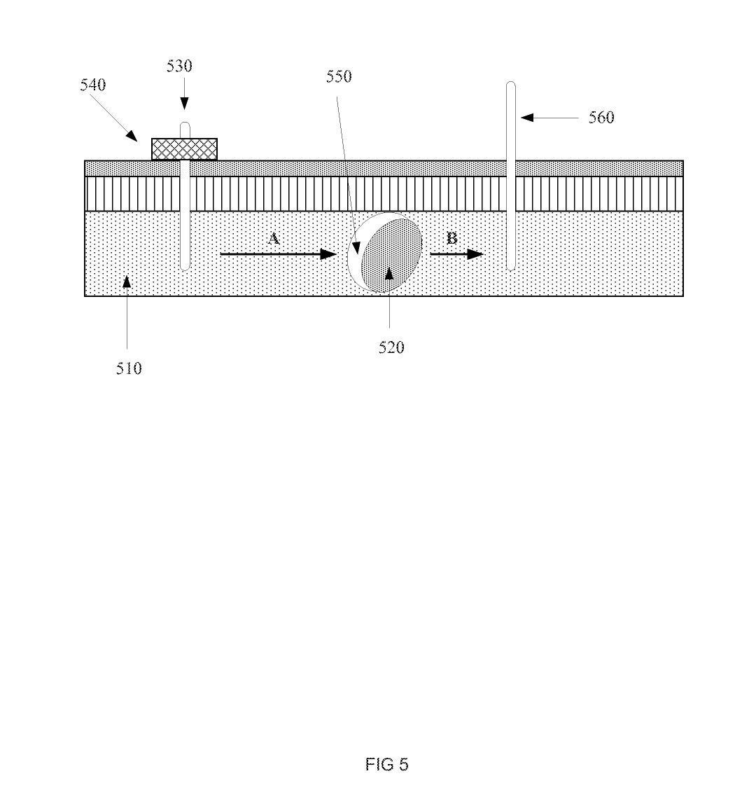

FIG. 5 depicts an example of a system that may use the non-limiting method for extracting a hydrocarbon as illustrated in the flow chart of FIG. 4. Depicted in FIG. 5 is an example of a subterranean formation 510 in which a reservoir 520 of a hydrocarbon may be found. One or more injection wells 530 may be bored into the formation 510 to allow a monomer-containing solution to be injected therein. A pumping device 540 may be associated with the injection well 530 for that purpose. The pumping device 540 may pump or inject a monomer-containing solution into the formation 510 in such a manner that the monomer-containing solution may contact the hydrocarbon in the reservoir 520.

As disclosed above, the monomer-containing solution may include at least one monomer, and the solution may be characterized by a polymerization temperature above which the monomer may polymerize. The subterranean formation 510 may be at a formation temperature equal to or greater than the polymerization temperature. As a result, the monomer-containing solution may polymerize to form a polymer material 550. In one non-limiting example, the polymer material 550 may be in fluid contact with at least a portion of the hydrocarbon reservoir 520. In another non-limiting example, the polymer material 550 may be near, but not in fluid contact with, the hydrocarbon reservoir 520.

The monomer-containing solution may be allowed to polymerize for a polymerization time within the formation. Thereafter, a flooding fluid may be pumped through the injection well 530 by means of the pumping device 540. The flooding fluid may move in a direction A towards the hydrocarbon reservoir 520. As a result, the flooding fluid may sweep the polymer material 550 and the hydrocarbon reservoir 520 in a direction B towards at least one production well 560 that is also in fluid communication with the formation 510. In such a manner, the hydrocarbon may be extracted from the formation.

In order to illustrate the various features disclosed above, the following non-limiting examples are provided.

### EXAMPLES

### Example 1

### Method of Removing Hydrocarbon Materials from a Mature Oil Field

In one example, an oilfield may have a subterranean formation that includes a sandstone reservoir at a depth of about 2800 ft. (about 850 meters) with an average reservoir thickness of about 29 ft. (about 9 meters). The reservoir porosity may be about 18% and have a permeability of about 0.1 D (about 0.1×10⁻¹² m²). The reservoir pressure and temperature conditions may be about 2350 PSI (about 16 MPa) and about 180 degrees F. (about 82 degrees C.), respectively. The reservoir may contain a hydrocarbon material composed of brown oil with an API gravity of about 30°. Salts, such as NaCl, CaCl₂, MgCl₂, may be found in the subterranean formation associated with the hydrocarbon reservoir and may reduce the effectiveness of any of the components of the monomer-containing solution. About 1 pore volume (PV) of a pre-flush solution including low salinity water may be injected into the formation to remove the salts prior to the introduction of the monomer-containing solution. The monomer-containing solution may include about 20% by volume acrylamide monomer in water. The monomer-containing solution may further include formaldehyde (as a biocide) at about 0.3% by weight. About 0.8 pore volume (PV) of the monomer-containing solution may be injected into the subterranean formation. As the monomer-containing solution moves through the subterranean formation, monomers may occupy the pores within the formation and may polymerize in situ due to the formation temperature. The polymer size developed within the formation may vary and depend on the local geometry and size of the pores within the formation. It may be understood that small pore sizes may exclude high molecular weight polymers that may be too large to enter the pores.

The polymerization time for the reservoir disclosed in this example may be about 1000 hrs. The hydrocarbon may be removed from the subterranean formation through the use of an injection of about 1 PV of chase water.

The method disclosed above may reduce the residual oil saturation in the hydrocarbon reservoir from about 40%—frequently found after the application of secondary extraction techniques—to about 18%. The use of this method may result in an increase in oil production rate from about 350 BBL/day (about 2.5 kL/hr.) to about 800 BBL/day (about 5.5 kL/hr.), wherein BBL is the industry standard abbreviation for “barrel of oil” and corresponds to about 160 liters.

### Example 2

### System for Removing Material from a Mature Oil Field

In another example, a subterranean formation may include a sandstone reservoir at a depth of about 4000 ft. (about 1200 meters). The subterranean formation may have a porosity of about 30% and a permeability in the range of about 5 mD (about 0.005×10⁻¹² m²) to about 10 mD (about 0.01×10⁻¹² m²). The reservoir temperature and pressure may be about 180 degrees F. (about 80 degrees C.) and about 2000 PSI (about 14 MPa), respectively. The average pay zone thickness (that is, the average thickness of the subterranean formation having the hydrocarbon) for the reservoir in the formation may be about 60 ft. (about 20 meters). The hydrocarbon material in the formation may include waxy crude oil having a viscosity of about 50 cP (about 50 mPa·s) and an API gravity of about 20°. In this example, about 30% of the original oil in the formation may have been previously recovered using standard recovery techniques.

A recovery system for this exemplary subterranean formation configuration may include a regular five spot injection configuration including 4 injection wells surrounding one production well. Solutions may be injected through the injection wells by means of one or more high powered surface pumps, such as reciprocating and centrifugal pumps, used either separately or jointly.

About one pore volume of low salinity water may be injected as a pre-flush solution to reduce in situ salt concentration. Thereafter, about one pore volume of a monomer-containing solution including acrylamide monomer and sodium dodecyl sulphonate (SDS) may be injected. The acrylamide concentration may be about 30% by volume of water. The concentration of SDS may be greater than the critical micellar concentration at about 0.25 weight % to water. The polymerization time of the monomer-containing solution in situ may be about 1000 hours, and the injection of monomer-containing solution may occur for about 300 days at an injection rate of about 40 m³/day (about 1.7 m³/hr).

About 1.5 pore volume of chase water may be injected into the formation to recover additional hydrocarbon. By the use of this system, the hydrocarbon recovery rate may be increased from about 315 BBL/day (about 2 kL/hr.), at standard temperature and pressure, to about 943 BBL/day (about 6.25 kL/hr.), at standard temperature and pressure, with a concomitant reduction in water use of about 15% to about 70% as compared to standard recovery procedures.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated in this disclosure, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can, of course, vary. It is also to be understood that the terminology used in this disclosure is for the purpose of describing particular embodiments only, and is not intended to be limiting.

With respect to the use of substantially any plural and/or singular terms in this disclosure, those having skill in the art can translate from the plural to the singular and/or from the singular to the plural as is appropriate to the context and/or application. The various singular/plural permutations may be expressly set forth in this disclosure for sake of clarity.

It will be understood by those within the art that, in general, terms used in this disclosure, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or^{,} “B” or “A and B.”

As will be understood by one skilled in the art, for any and all purposes, such as in terms of providing a written description, all ranges disclosed in this disclosure also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed in this disclosure can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

From the foregoing, it will be appreciated that various embodiments of the present disclosure have been described for purposes of illustration, and that various modifications may be made without departing from the scope and spirit of the present disclosure. Accordingly, the various embodiments disclosed are not intended to be limiting, with the true scope and spirit being indicated by the following claims.

What is claimed is:

1. A method of treating a subterranean formation, the method comprising:
contacting the subterranean formation with a monomer-containing solution; and
allowing at least a portion of the monomer-containing solution to at least partially polymerize in the subterranean formation for a polymerization time, thereby forming therein at least one polymer,
wherein:
the monomer-containing solution comprises at least one monomer,
the subterranean formation has a formation temperature,
the monomer-containing solution has a polymerization temperature above which the at least one monomer in the monomer-containing solution is thermally catalyzed to form the at least one polymer, and
the formation temperature is equal to or greater than the polymerization temperature.

2. The method of claim 1, wherein contacting the subterranean formation with a monomer-containing solution comprises pumping the monomer-containing solution into the subterranean formation via at least one injection well.

3. The method of claim 1, wherein the monomer-containing solution does not comprise a polymerization initiator of the at least one monomer.

4. The method of claim 1, wherein the polymer has an average molecular weight of about 0.01 kD to about 10 kD.

5. The method of claim 4, wherein the average molecular weight of the polymer depends at least in part on the polymerization time.

6. The method of claim 1, wherein the polymerization temperature is about 50 degrees C. to about 300 degrees C.

7. The method of claim 1, further comprising determining the polymerization time based at least in part on a characteristic of the subterranean formation.

8. The method of claim 7, wherein the characteristic of the subterranean formation comprises one or more of a formation chemical composition, a formation porosity, a formation density, a formation pore morphology, a formation permeability, and a formation compressibility.

9. The method of claim 1, further comprising determining the polymerization time based at least in part on one or more of the polymerization temperature, a concentration of the at least one monomer in the monomer-containing solution, the formation temperature, a pore size of the subterranean formation, and a characteristic of the subterranean formation.

10. The method of claim 1, wherein the polymerization time is about 0.5 hours to about 1500 hours.

11. The method of claim 1, further comprising:
measuring the formation temperature; and
measuring a pore size of the subterranean formation.

12. A method of extracting a hydrocarbon material from a subterranean formation, the method comprising:
contacting the subterranean formation with a monomer-containing solution;
allowing at least a portion of the monomer-containing solution to at least partially polymerize in the subterranean formation for a polymerization time, thereby forming therein at least one polymer;
injecting a flooding fluid into the subterranean formation; and
removing the hydrocarbon material from the subterranean formation,
wherein:
the monomer-containing solution comprises at least one monomer,
the subterranean formation has a formation temperature,
the monomer-containing solution has a polymerization temperature above which the at least one monomer in the monomer-containing solution is thermally catalyzed to form the at least one polymer, and
the formation temperature is equal to or greater than the polymerization temperature.

13. The method of claim 12, wherein the hydrocarbon material comprises one or more of heavy oil, light oil, brown oil, shale oil, waxy oil, and gas condensate.

14. The method of claim 12, further comprising determining the polymerization time based at least in part on a characteristic of the hydrocarbon material.

15. The method of claim 14, wherein the characteristic of the hydrocarbon material comprises one or more of a material chemical composition, a material density, a material viscosity, and an API gravity.

16. The method of claim 12, wherein the flooding fluid comprises one or more of water, a solvent, an alkali, a surfactant, a co-surfactant, a biocide, an acid, a metal catalyst, a plurality of nanoparticles, and a clay.

17. A system comprising:
at least one injection well in fluid communication with at least one subterranean formation;
at least one production well in fluid communication with the at least one subterranean formation; and
a pumping device configured to pump a monomer-containing solution into the at least one subterranean formation via the at least one injection well,
wherein:
the monomer-containing solution comprises at least one monomer,
the subterranean formation has a formation temperature,
the monomer-containing solution has a polymerization temperature above which the at least one monomer in the monomer-containing solution is thermally catalyzed to form at least one polymer, and
the formation temperature is equal to or greater than the polymerization temperature.

18. The system of claim 17, wherein the at least one monomer in the monomer-containing solution comprises one or more of a saccharide, an acrylamide, acrylic acid, a salt of acrylic acid, and a vinyl alcohol.

19. The system of claim 17, wherein the monomer-containing solution further comprises one or more of a solvent, a surfactant, an alkali material, and at least one proppant.

20. The system of claim 17, wherein the monomer-containing solution does not comprise a polymerization initiator of the at least one monomer.

21. The system of claim 17, wherein the at least one injection well comprises a plurality of injection wells in fluid communication with the at least one subterranean formation.

22. The system of claim 17, wherein the at least one production well comprises a plurality of production wells in fluid communication with the at least one subterranean formation.
